(19) United States
(12) Patent Application Publication
(10) Pub. No.: US 2022/0350909 A1
(43) Pub. Date: Nov. 3, 2022

(54) INFORMATION COLLECTION APPARATUS, INFORMATION COLLECTING METHOD, AND PROGRAM

(71) Applicant: NEC Corporation, Minato-ku,Tokyo (JP)

(72) Inventor: Masaru KAWAKITA, Tokyo (JP)

(73) Assignee: NEC Corporation, Minato-ku,Tokyo (JP)

(21) Appl. No.: 17/640,478

(22) PCT Filed: Sep. 24, 2019
(86) PCT No.: PCT/JP2019/037283

§ 371 Date: Mar. 4, 2022

(51) Int. Cl. G06F 21/62; G06F 16/955

(52) U.S. Cl. CPC G06F 21/6218; G06F 16/955; G06F 2221/2133

(57) ABSTRACT

In order to efficiently collect web contents that are accessible by answering correct answer character strings, an apparatus includes a collecting unit 111 configured to collect first web content by using web address information, an extracting unit 113 configured to extract, from the first web content, question image information obtained by applying an image effect to a correct answer character string for accessing second web content, and a discriminating unit 115 configured to discriminate the correct answer character string from the question image information, by using a discriminant model associated with the web address information among two or more discriminant models for discriminating a character string from an image.

### BACKGROUND

### Technical Field

The present invention relates to an information collection apparatus, an information collecting method, and a program for collecting web content information.

### Background Art

For the purpose of preventing an increase in server load due to machine collection and other purposes, authentication systems are used to verify a web site visitor as a human. A known example of such an authentication system includes a Completely Automated Public Turing test to tell Computers and Humans Apart (CAPTCHA), which is a kind of a reverse turing test. For example, Patent Literatures 1 and 2 disclose apparatuses for performing such a reverse turing test.

### CITATION LIST

### Patent Literature

[PTL 1] JP 2013-061971 A
[PTL 2] JP 2014-130599 A

### SUMMARY

### Technical Problem

Patent Literatures 1 and 2 described above disclose a question image using CAPTCHA, from which a correct answer character string may be estimated by a recognition process based on visual characteristics of letters, such as Optical Character Recognition/Reader (OCR).

However, for example, as to a reverse turing test that is conducted to access an underground site, etc., an image effect that interferes with machine reading of letters tends to be applied in order to impose a stricter access restriction. A character string with such an image effect is hardly estimated by using a recognition process based on visual characteristics of letters, as described above. For this reason, it is difficult to efficiently collect contents in a certain web site, such as an underground site described above.

An example object of the present invention is to provide an information collection apparatus, an information collecting method, and a program that enable efficiently collect web contents that are accessible by answering correct answer character strings.

### Solution to Problem

An aspect of the present invention provides an information collection apparatus including:

a collecting unit configured to collect first web content by using web address information;

an extracting unit configured to extract, from the first web content, question image information obtained by applying an image effect to a correct answer character string for accessing second web content; and

a discriminating unit configured to discriminate the correct answer character string from the question image information, by using a discriminant model associated with the web address information among two or more discriminant models for discriminating a character string from an image,

wherein each of the two or more discriminant models is a trained model machine-learned using learning data that are a plurality of candidate question images generated from a plurality of candidate correct answer character strings in accordance with an image generating rule including a process of adding a background image.

An aspect of the present invention provides an information collecting method including:

collecting first web content by using web address information;

extracting, from the first web content, question image information obtained by applying an image effect to a correct answer character string for accessing second web content; and

discriminating the correct answer character string from the question image information, by using a discriminant model associated with the web address information among two or more discriminant models for discriminating a character string from an image,

wherein each of the two or more discriminant models is a trained model machine-learned using learning data that are a plurality of candidate question images generated from a plurality of candidate correct answer character strings in accordance with an image generating rule including a process of adding a background image.

An aspect of the present invention provides an information collecting method including:

collecting first web content by using web address information;

extracting, from the first web content, question image information obtained by applying an image effect to a correct answer character string for accessing second web content; and

discriminating the correct answer character string from the question image information, by using a discriminant model associated with the web address information among two or more discriminant models for discriminating a character string from an image,

wherein each of the two or more discriminant models is a trained model machine-learned using learning data that are a plurality of candidate question images generated from a plurality of candidate correct answer character strings in accordance with an image generating rule including a process of adding a background image.

### Advantageous Effects of Invention

An aspect of the present invention enables appropriately carrying a target object by one or more carrying apparatuses. Note that, according to the present invention, instead of or together with the above effects, other effects may be exerted.

### BRIEF DESCRIPTION OF THE DRAWINGS

FIG. 1 is a block diagram illustrating an example of a hardware configuration of an information collection apparatus 100 according to a first example embodiment;

FIG. 2 is a block diagram illustrating an example of a configuration implemented by the information collection apparatus 100;

FIG. 3 is a diagram illustrating specific examples of types of image generating rules;

FIG. 4 is a diagram schematically illustrating processing of generating discriminant models;

FIG. 5 is a diagram illustrating specific examples of information stored in a discriminant model storage unit 121; and

FIG. 6 is a block diagram illustrating an example of a schematic configuration of the information collection apparatus 100 according to a second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.
1. Overview of Example Embodiments of Present Invention
2. First Example Embodiment
   2.1. Configuration of Information Collection Apparatus 100
   2.2. Technical Features
3. Second Example Embodiment
   3.1. Configuration of Information Collection Apparatus 100
   3.2. Technical Features
4. Other Example Embodiments

### 1. Overview of Example Embodiments of Present Invention

First, an overview of example embodiments of the present invention will be described.

### (1) Technical Issue

For the purpose of preventing an increase in server load due to machine collection and other purposes, authentication systems are used to verify a web site visitor as a human. A known example of such an authentication system includes a Completely Automated Public Turing test to tell Computers and Humans Apart (CAPTCHA), which is a kind of a reverse turing test.

Form a question image using CAPTCHA as described above, it may be possible to estimate a correct answer character string by a recognition process based on visual characteristics of letters, such as Optical Character Recognition/Reader (OCR).

However, for example, as to a reverse turing test that is conducted to access an underground site, etc., an image effect that interferes with machine reading of letters tends to be applied in order to impose a stricter access restriction. A character string with such an image effect is hardly estimated by using a recognition process based on visual characteristics of letters, as described above. For this reason, it is difficult to efficiently collect contents in a certain web site, such as an underground site described above.

In view of this, an example object of the example embodiments is to efficiently collect web contents that are accessible by answering correct answer character strings.

### (2) Technical Features

The example embodiments of the present invention include collecting first web content by using web address information, extracting, from the first web content, question image information in which an image effect is applied to a correct answer character string for accessing second web content, estimating a first image generating rule used in generating the question image information, in accordance with the web address information among two or more image generating rules including a process of adding a background image, and discriminating the correct answer character string from the question image information, by using a discriminant model based on a plurality of candidate question images generated from a plurality of candidate correct answer character strings in accordance with the first image generating rule.

This enables, for example, efficiently collecting web contents that are accessible by answering correct answer character strings. Note that the above-described technical features are specific examples of the example embodiments of the present invention, and of course, the example embodiments of the present invention are not limited to the above-described technical features.

### 2. First Example Embodiment

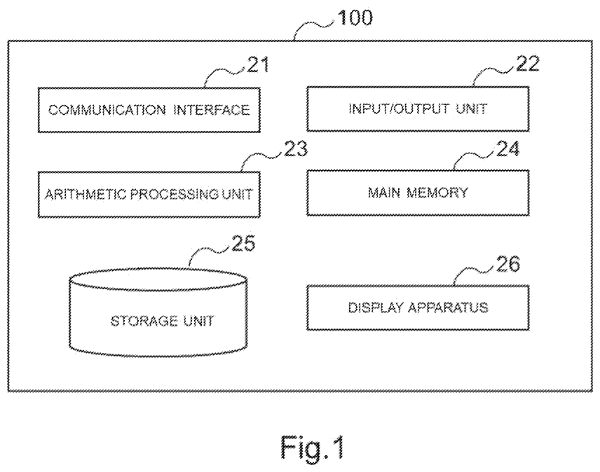

A description will be given of a first example embodiment employing the present invention, with reference to FIGS. 1 to 5.

<2.1. Configuration of Information Collection Apparatus 100>

FIG. 1 is a block diagram illustrating an example of a hardware configuration of an information collection apparatus 100 according to a first example embodiment. With reference to FIG. 1, the information collection apparatus 100 includes a communication interface 21, an input/output unit 22, an arithmetic processing unit 23, a main memory 24, and a storage unit 25.

The communication interface 21 transmits and receives data with an external apparatus. For example, the communication interface 21 communicates with an external apparatus via a wired communication path.

The arithmetic processing unit 23 is, for example, a Central Processing Unit (CPU) or a Graphics Processing Unit (GPU). The main memory 24 is, for example, a Random Access Memory (RAM) or a Read Only Memory (ROM). The storage unit 25 is, for example, a Hard Disk Drive (HDD), a Solid State Drive (SSD), or a memory card. The storage unit 25 may be a memory, such as a RAM or a ROM.

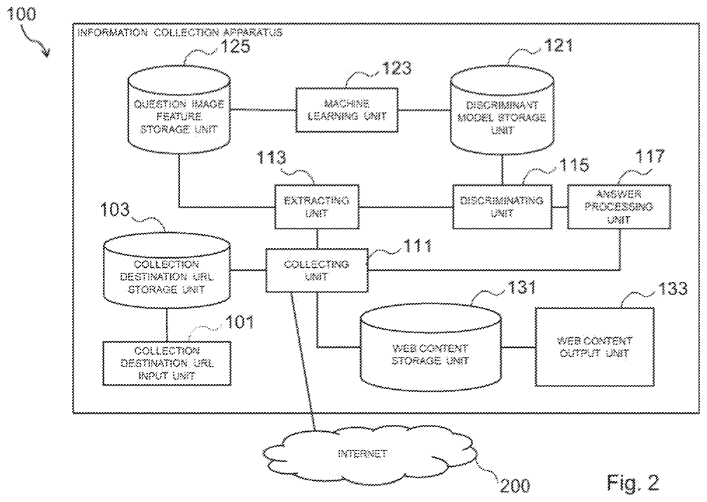

The information collection apparatus 100 reads out, for example, carrying control programs stored in the storage unit 25 to the main memory 24 and the arithmetic processing unit 23 executes the programs, whereby functional units as illustrated in FIG. 2 are implemented. These programs may be executed after being read out to the main memory 24 or may be executed without being read out to the main memory 24. The main memory 24 and the storage unit 25 also store information and data that are stored by components of the information collection apparatus 100.

The above-described programs can be stored by using various types of non-transitory computer readable media (non-transitory computer readable medium) and can be provided to the computer. The non-transitory computer readable medium includes various types of tangible storage medium. Examples of the non-transitory computer readable medium include magnetic recording media (e.g., a flexible disk, a magnetic tape, and a hard disk drive), optical magnetic recording media (e.g., a magneto-optical disc), a Compact Disc-ROM (CD-ROM), a CR-Recordable (CD-R), a CR-ReWritable (CD-R/W), semiconductor memories (such as a mask ROM, a PROM (Programmable ROM), an Erasable PROM (EPROM), a flash ROM, and a RAM. The programs may be provided to the computer by various types of transitory computer readable medium. Examples of the transitory computer readable medium include electric signals, optical signals, and electromagnetic waves. The transitory computer readable medium can provide the programs to the computer via a wired communication path, such as a cable or an optical fiber, or a wireless communication path.

The display apparatus 26 is an apparatus that displays a screen corresponding to drawing data processed by the arithmetic processing unit 23, such as a Liquid Crystal Display (LCD), a Cathode Ray Tube (CRT) display, or a monitor.

FIG. 2 is a block diagram illustrating an example of a configuration implemented by the information collection apparatus 100.

With reference to FIG. 2, the information collection apparatus 100 includes a collection destination URL input unit 101 and a collection destination URL storage unit 103. The information collection apparatus 100 includes a collecting unit 111, an extracting unit 113, a discriminating unit 115, and an answer processing unit 117. Furthermore, the information collection apparatus 100 includes a discriminant model storage unit 121, a machine learning unit 123, and a question image feature storage unit 125. Specific operation or processing of each of these functional units will be described later.

<2.2. Technical Features>

Next, technical features of the first example embodiment will be described.

In the first example embodiment, the information collection apparatus 100 (collecting unit 111) collects first web content by using web address information. The information collection apparatus 100 (extracting unit 113) then extracts, from the first web content, question image information in which an image effect is applied to a correct answer character string for accessing second web content. Thereafter, the information collection apparatus 100 (discriminating unit 115) discriminates the correct answer character string from the question image information, by using a discriminant model associated with the web address information among two or more discriminant models for discriminating a character string from an image. Here, each of the two or more discriminant models is a trained model machine-learned using learning data that are a plurality of candidate question images generated from a plurality of candidate correct answer character strings in accordance with an image generating rule including a process of adding a background image.

(1) Collection of First Web Content

The collection of first web content is performed as follows, for example.

First, a user or a management system inputs a set of URLs that indicate locations of contents to be collected, by using the collection destination URL input unit 101. The set of URLs is stored in the collection destination URL storage unit 103. Note that the collection destination URL input unit 101 may be a keyboard, an external storage apparatus, or an external network that is connected to the information collection apparatus 100.

Then, the collecting unit 111 reads one URL among the set of the URLs stored in the collection destination URL storage unit 103, as the web address information. The collecting unit 111 then accesses the Internet to obtain web content (the first web content) indicated by the web address information and then stores a pair of the URL (the web address information) and the first web content in a web content storage unit 131.

The collecting unit 111 is further configured to extract a URL contained in the first web content and reinput the extracted URL. The collecting unit 111 may use an access support function, such as a proxy, necessary to access a hidden overlay network, in case that the extracted URL is for an underground site, for example.

(2) Question Image Information

Extraction of the question image information is performed as follows, for example.

For example, the extracting unit 113 extracts the question image information from the first web content by using information stored in the question image feature storage unit 125. Here, the question image feature storage unit 125 stores, for example, regular expressions for extracting a question image from content accessible by each URL stored in the collection destination URL storage unit 103.

In other words, the extracting unit 113 compares the pair of the web address information and the first web content collected by the collecting unit 111, with a pair of the URL and the regular expressions for extracting a question image stored in the question image feature storage unit 125. Thus, the extracting unit 113 can extract the question image information from the first web content in accordance with the comparison result.

(3) Image Generating Rules

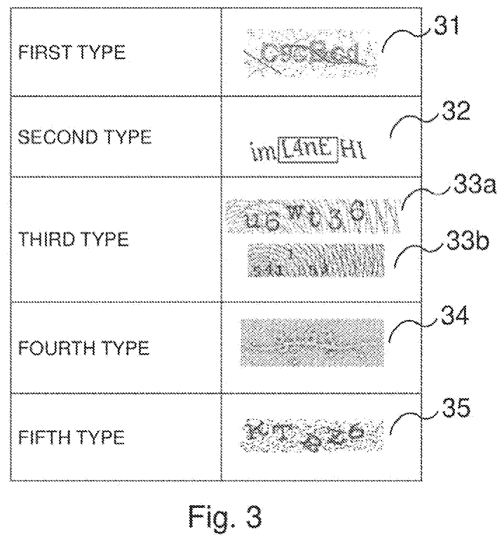

FIG. 3 is a diagram illustrating specific examples of types of image generating rules. For example, the image generating rules are grouped into four types, as illustrated in FIG. 3.

A question image 31 that is generated in accordance with a first type image generating rule has characteristics in which, for example, color tones of a background and letters are similar to each other, and letters are distorted. A question image 32 that is generated in accordance with a second type image generating rule has characteristics in which, for example, letters inside a background figure are targets to be answered and are distorted. Question images 33a and 33b that are generated in accordance with a third type image generating rule have characteristics in which, for example, letters are dispersed and are embedded in a background image. A question image 34 that is generated in accordance with a fourth type image generating rule has characteristics in which, for example, color tones of a background and letters are similar to each other, and letters are dispersed. A question image 35 that is generated in accordance with a fifth type image generating rule has characteristics in which, for example, color tones of a background and letters are similar to each other, and letters are dispersed. These first to fifth type image generating rules can be understood as questioning rules of, for example, a Completely Automated Public Turing test to tell Computers and Humans Apart (CAPTCHA).

Each of the first to the fifth type image generating rules includes setting a letter type contained in a character string, setting the number of letters contained in the character string, setting information related to a font for displaying the character string, and setting information related to the background image. These plurality of settings enable generating question image information having the above-described characteristics from a correct answer character string.

(4) Discriminant Models

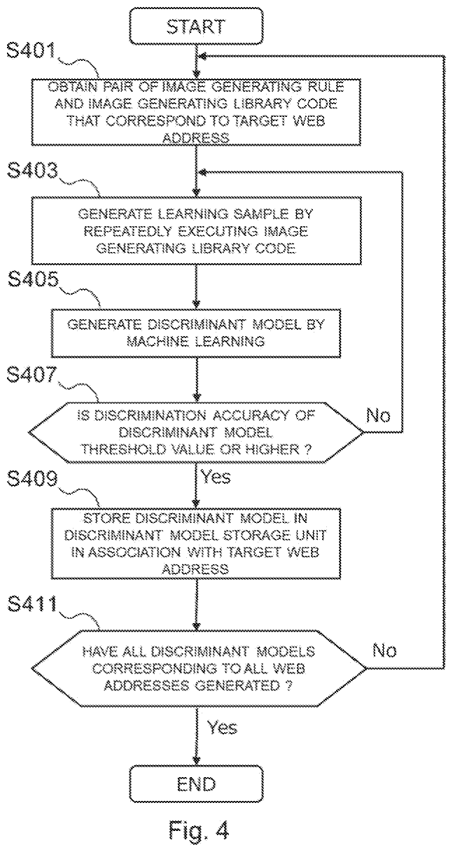

For example, each of the two or more discriminant models is generated as described below, for example, by the machine learning unit 123. FIG. 4 is a diagram schematically illustrating processing of generating discriminant models.

With reference to FIG. 4, the machine learning unit 123 obtains a pair of an image generating rule and an image generating library code that are associated with one web address (hereinafter also referred to as a “target web address”) stored in the collection destination URL storage unit 103, in step S401, and advances to step S403.

For example, the machine learning unit 123 may obtain a pair of an image generating rule and an image generating library code that are associated with a target web address by accessing the question image feature storage unit 125. In this case, the question image feature storage unit 125 stores the pair of the image generating rule and the image generating library code in association with each other for each web address stored in the collection destination URL storage unit 103. Such an associating process is performed by a user operation, for example.

In step S403, the machine learning unit 123 generates a learning sample by repeatedly executing the image generating library code, which is obtained in step S401.

Specifically, in step S403, the machine learning unit 123 sets a letter type and the number of letters that a candidate correct answer character string can have, in accordance with the image generating rule associated with the target web address, and randomly generates a candidate correct answer character string based on these set conditions. In one example, the letter type is set to an alphanumeric character, and the number of letters is set to 6 to 8.

The machine learning unit 123 sets, in accordance with the image generating rule, information related to a font for displaying a character string (such as type of font, thickness of letters, and color of letters), and information related to a background image (such as pattern, thickness of pattern, and color of pattern). The machine learning unit 123 then generates a candidate question image corresponding to each candidate correct answer character string, based on these set conditions.

In step S405, the machine learning unit 123 generates a discriminant model by using learning data that is the learning sample (the plurality of correct answer character strings and the plurality of candidate question images) generated in step S403, and advances to step S407. Here, the discriminant model is obtained by an arbitrary machine learning algorithm. For example, the algorithm of machine learning may be a support vector machine or deep learning. The discriminant model includes, for example, an evaluation function for evaluating a correlation between image information having the arbitrary number of pixels (brightness information and color difference information of each pixel) and a candidate correct answer character string. On the basis of result of evaluation using such an evaluation function, a correct answer character string can be discriminated from an image.

In step S407, the machine learning unit 123 determines whether discrimination accuracy of the discriminant model is a threshold value or higher. If the discrimination accuracy is the threshold value or higher (S407: Yes), the machine learning unit 123 advances to step S409, and if the discrimination accuracy is less than the threshold value (S407: No), the machine learning unit 123 returns to step S403 to repeat steps S403 and S405.

In step S409, the machine learning unit 123 stores the discriminant model, which is generated in step S405, in the discriminant model storage unit 121 in association with the target web address, and advances to step S411.

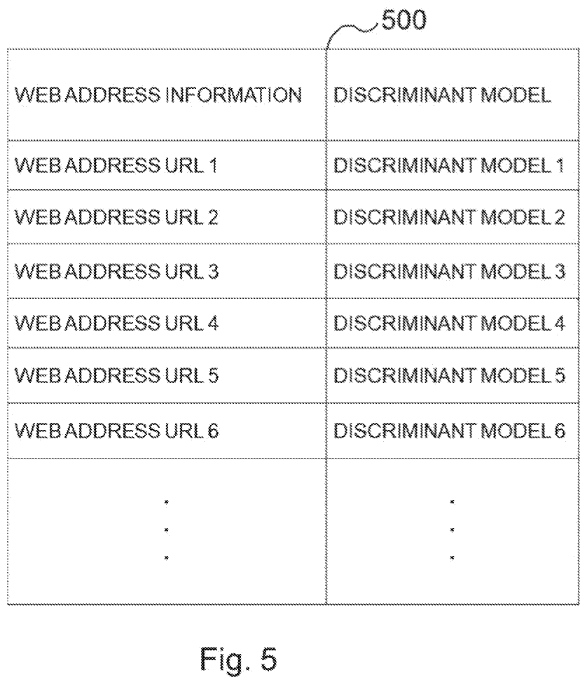

FIG. 5 is a diagram illustrating specific examples of information stored in the discriminant model storage unit 121. With reference to FIG. 5, the discriminant model storage unit 121 stores a data table 500 in which each of two or more discriminant models is associated with web address information.

In step S411, the machine learning unit 123 determines whether all discriminant models corresponding to respective web addresses stored in the collection destination URL storage unit 103 are generated. If all discriminant models are generated (S411: Yes), the machine learning unit 123 terminates the processing illustrated in FIG. 4, and if one or more discriminant models are still not generated (S411: No), the machine learning unit 123 returns to step S401 to repeat the processing in steps S401 to S409.

The machine learning unit 123 can generate discriminant models in accordance with the processing illustrated in FIG. 4.

(5) Discrimination of Correct Answer Character String Using Discriminant Model

The discriminating unit 115 specifies a discriminant model associated with the web address information by referring to the discriminant model storage unit 121, and discriminates the correct answer character string from the question image information by using the specified discriminant model. For example, with reference to the data table 500 illustrated in FIG. 5, assuming that the web address information is a web address URL 1, the discriminating unit 115 can discriminate the correct answer character string from the question image information by using a discriminant model 1 associated with the web address URL 1.

(6) Answer Processing

The answer processing unit 117 answers the question image information with the use of the correct answer character string that is discriminated as described above. In this case, the collecting unit 111 then collects the second web content in response to the answering.

In other words, the collecting unit 111 transmits the answer information to the server apparatus indicated by the web address information, via the Internet 200. As a response to this, the collecting unit 111 receives information on successful login transmitted from the server apparatus. The information on successful login is, for example, a Set-Cookie header. Note that the information on successful login is not limited to a Set-Cookie header and may be a Cookie header of another type, such as a Set-Cookie2 header. Thereafter, the collecting unit 111 collects the second web content by using this information on successful login and stores the second web content in the web content storage unit 131.

(7) Browsing Processing

The web content output unit 133 outputs information related to the second content in response to, for example, a request from a user. For example, the information related to the second content is displayed on the display apparatus 26 of the information collection apparatus 100. Thus, a user can efficiently browse the information related to the second content, for example, without comprehending a question image information and answering the question image information with a correct answer character string. In one example in which the second content contains information of exchange on an underground site, a user can efficiently collect these pieces of information of exchange only by accessing the information collection apparatus 100, and the user can utilize the information of exchange for security measures, crime prevention, and the like.

### 3. Second Example Embodiment

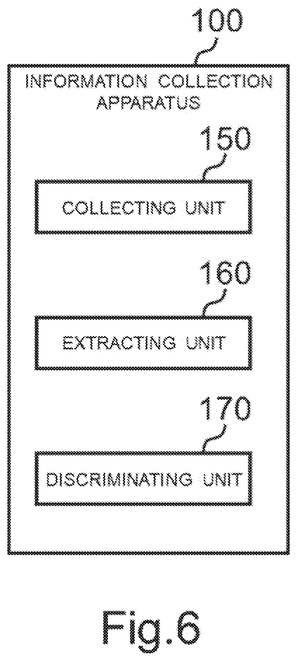

Next, a description will be given of a second example embodiment of the present invention with reference to FIG. 6. The above-described first example embodiment is a concrete example embodiment, whereas the second example embodiment is a more generalized example embodiment.

<3.1. Configuration of Information Collection Apparatus 100>

FIG. 6 is a block diagram illustrating an example of a schematic configuration of an information collection apparatus 100 according to the second example embodiment. With reference to FIG. 6, the information collection apparatus 100 includes a collecting unit 150, an extracting unit 160, and a discriminating unit 170.

The collecting unit 150, the extracting unit 160, and the discriminating unit 170 may be implemented with one or more processors, and a memory (e.g., a nonvolatile memory and/or a volatile memory) and/or a hard disk. The collecting unit 150, the extracting unit 160, and the discriminating unit 170 may be implemented with the same processor or may be implemented with separate processors. The memory may be included in the one or more processors or may be provided outside the one or more processors.

<3.2. Technical Features>

Technical features of the second example embodiment will be described.

In the second example embodiment, the information collection apparatus 100 (collecting unit 150) collects first web content by using web address information. The information collection apparatus 100 (extracting unit 160) then extracts, from the first web content, question image information in which an image effect is applied to a correct answer character string for accessing second web content. Thereafter, the information collection apparatus 100 (discriminating unit 170) discriminates the correct answer character string from the question image information, by using a discriminant model associated with the web address information among two or more discriminant models for discriminating a character string from an image. Here, each of the two or more discriminant models is a trained model machine-learned using learning data that are a plurality of candidate question images generated from a plurality of candidate correct answer character strings in accordance with an image generating rule including a process of adding a background image.

Relationship with First Example Embodiment

In one example, the collecting unit 150, the extracting unit 160, and the discriminating unit 170 of the second example embodiment may perform the operations of the collecting unit 111, the extracting unit 113, and the discriminating unit 115 of the first example embodiment, respectively. In this case, the descriptions of the first example embodiment may be applicable to the second example embodiment.

Note that the second example embodiment is not limited to this example.

The second example embodiment has been described above. The second example embodiment enables, for example, efficiently collecting web contents that are accessible by answering correct answer character strings.

### 4. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including constituent elements (e.g., the collecting unit, the extracting unit, and/or the discriminating unit) of the information collection apparatus described in the Specification (e.g., one or more apparatuses (or units) among a plurality of apparatuses (or units) constituting the information collection apparatus or a module for one of the plurality of apparatuses (or units)) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

An information collection apparatus comprising:

a collecting unit configured to collect first web content by using web address information;

an extracting unit configured to extract, from the first web content, question image information obtained by applying an image effect to a correct answer character string for accessing second web content; and

a discriminating unit configured to discriminate the correct answer character string from the question image information, by using a discriminant model associated with the web address information among two or more discriminant models for discriminating a character string from an image,

wherein each of the two or more discriminant models is a trained model machine-learned using learning data that are a plurality of candidate question images generated from a plurality of candidate correct answer character strings in accordance with an image generating rule including a process of adding a background image.

### (Supplementary Note 2)

The information collection apparatus according to Supplementary Note 1, wherein the image generating rule further includes setting a letter type contained in the character string.

### (Supplementary Note 3)

The information collection apparatus according to Supplementary Note 1 or 2, wherein the image generating rule further includes setting a number of letters contained in the character string.

### (Supplementary Note 4)

The information collection apparatus according to any one of Supplementary Notes 1 to 3, wherein each of the two or more image generating rules further includes setting information related to a font for displaying the character string.

### (Supplementary Note 5)

The information collection apparatus according to any one of Supplementary Notes 1 to 4, wherein each of the two or more image generating rules further includes setting information related to the background image.

### (Supplementary Note 6)

The information collection apparatus according to any one of Supplementary Notes 1 to 5, wherein the discriminating unit is configured to specified the discriminant model associated with the web address information by referring to a data table in which each of the two or more discriminant models is associated with web address information.

### (Supplementary Note 7)

The information collection apparatus according to any one of Supplementary Notes 1 to 6, further comprising

an answer processing unit configured to answer the question image information by using the discriminated correct answer character string, and

wherein the collecting unit is configured to further collect the second web content in response to the answering.

### (Supplementary Note 8)

The information collection apparatus according to Supplementary Note 7, further comprising

a web content output unit configured to output information related to the second web content in response to a request from a user.

### (Supplementary Note 9)

An information collecting method comprising:

collecting first web content by using web address information;

extracting, from the first web content, question image information obtained by applying an image effect to a correct answer character string for accessing second web content; and

discriminating the correct answer character string from the question image information, by using a discriminant model associated with the web address information among two or more discriminant models for discriminating a character string from an image,

wherein each of the two or more discriminant models is a trained model machine-learned using learning data that are a plurality of candidate question images generated from a plurality of candidate correct answer character strings in accordance with an image generating rule including a process of adding a background image.

### (Supplementary Note 10)

A program that causes a computer to execute:

collecting first web content by using web address information;

extracting, from the first web content, question image information obtained by applying an image effect to a correct answer character string for accessing second web content; and

discriminating the correct answer character string from the question image information, by using a discriminant model associated with the web address information among two or more discriminant models for discriminating a character string from an image,

wherein each of the two or more discriminant models is a trained model machine-learned using learning data that are a plurality of candidate question images generated from a plurality of candidate correct answer character strings in accordance with an image generating rule including a process of adding a background image.

### INDUSTRIAL APPLICABILITY

Web contents that are accessible by answering correct answer character strings can be efficiently collected in the information collection apparatus that collects web contents by accessing a web site.

### REFERENCE SIGNS LIST

100 Information Collection Apparatus
101 Collection Destination URL Input Unit
103 Collection Destination URL Storage Unit
111, 150 Collecting Unit
113, 160 Extracting Unit
115, 170 Discriminating Unit
117 Answer Processing Unit
121 Discriminant Model Storage Unit
123 Machine Learning Unit
125 Question Image Feature Storage Unit
131 Web Content Storage Unit
133 Web Content Output Unit
200 Internet

What is claimed is:

1. An information collection apparatus comprising:
a memory storing instructions; and
one or more processors configured to execute the instructions to:
collect first web content by using web address information;
extract, from the first web content, question image information obtained by applying an image effect to a correct answer character string for accessing second web content; and
discriminate the correct answer character string from the question image information, by using a discriminant model associated with the web address information among two or more discriminant models for discriminating a character string from an image,
wherein each of the two or more discriminant models is a trained model machine-learned using learning data that are a plurality of candidate question images generated from a plurality of candidate correct answer character strings in accordance with an image generating rule including a process of adding a background image.

2. The information collection apparatus according to claim 1, wherein the image generating rule further includes setting a letter type contained in the character string.

3. The information collection apparatus according to claim 1, wherein the image generating rule further includes setting a number of letters contained in the character string.

4. The information collection apparatus according to claim 1, wherein each of two or more image generating rules further includes setting information related to a font for displaying the character string.

5. The information collection apparatus according to claim 1, wherein each of two or more image generating rules further includes setting information related to the background image.

6. The information collection apparatus according to claim 1, wherein the one or more processors are configured to execute the instructions to specified the discriminant model associated with the web address information by referring to a data table in which each of the two or more discriminant models is associated with web address information.

7. The information collection apparatus according to claim 1, wherein the one or more processors are configured to execute the instructions to:
answer the question image information by using the discriminated correct answer character string, and
collect the second web content in response to the answering.

8. The information collection apparatus according to claim 7, wherein the one or more processors are configured to execute the instructions to output information related to the second web content in response to a request from a user.

9. An information collecting method comprising:
collecting first web content by using web address information;
extracting, from the first web content, question image information obtained by applying an image effect to a correct answer character string for accessing second web content; and
discriminating the correct answer character string from the question image information, by using a discriminant model associated with the web address information among two or more discriminant models for discriminating a character string from an image,
wherein each of the two or more discriminant models is a trained model machine-learned using learning data that are a plurality of candidate question images generated from a plurality of candidate correct answer character strings in accordance with an image generating rule including a process of adding a background image.

10. A non-transitory computer readable recording medium storing a program that causes a computer to execute:
collecting first web content by using web address information;
extracting, from the first web content, question image information obtained by applying an image effect to a correct answer character string for accessing second web content; and
discriminating the correct answer character string from the question image information, by using a discriminant model associated with the web address information among two or more discriminant models for discriminating a character string from an image,
wherein each of the two or more discriminant models is a trained model machine-learned using learning data that are a plurality of candidate question images generated from a plurality of candidate correct answer character strings in accordance with an image generating rule including a process of adding a background image.
